(19) United States
(12) Patent Application Publication
(10) Pub. No.: US 2010/0047681 A1
(43) Pub. Date: Feb. 25, 2010

(54) POWER STORAGE DEVICE AND MANUFACTURING METHOD THEREOF

(76) Inventor: Masahiko Mitsui, Toyota-shi (JP)

Correspondence Address: KENYON & KENYON LLP, 1500 K STREET N.W., SUITE 700, WASHINGTON, DC, 20005, US

(21) Appl. No.: 12/520,958

(22) PCT Filed: Dec. 27, 2007
(86) PCT No.: PCT/IB07/04111

§ 371 Date: Jun. 23, 2009

(30) Foreign Application Priority Data
Dec. 28, 2006 (JP) 2006-355918

(51) Int. Cl. H01M 6/02; H01M 6/00

(52) U.S. Cl. 429/120; 29/623.2

(57) ABSTRACT

In a power storage unit in which a bipolar battery is covered with a resin body, at least one through passage is formed to extend through the resin body, and a heat exchange medium is introduced into the through passage so that heat is exchanged between the heat exchange medium and the bipolar battery when the heat exchange medium flows thorough the through passage. The heat exchange medium may be a cooling medium or a heating medium. This configuration promotes heat release from the resin body from which heat cannot be sufficiently released.

### FIELD OF THE INVENTION

The invention relates to a power storage device that is covered with resin, and a manufacturing method thereof.

### BACKGROUND OF THE INVENTION

As first related art, a method related to a bipolar battery is available. In the method, in the case where the bipolar battery includes a sheet battery element, and the bipolar battery is a lithium secondary battery which may deteriorate upon contact with moisture, the sheet battery element is housed in a package made of a waterproof film.

In addition, as second related art, a method of manufacturing a waterproof casing in a lithium battery or a polymer lithium battery used in a compact-size electric device, such as a cellular phone, is available. The casing is constituted by a plurality of members (hereinafter, referred to as “casing members”). In the method, the casing members are attached to a mold, and adhesive resin is injected through an injection hole formed in the mold, so that the injected resin is filled in a channel that extends along each joint portion to surround each joint portion, and that does not contact inner components of the battery. Then, the injected adhesive resin is cured.

According to this method, areas around the joint portions of the casing members are covered with the adhesive resin, thereby making the joint portions waterproof.

According to the first related art, the battery is made waterproof. However, if the battery according to the first related art is provided and used in a vehicle, in particular, an electric vehicle, a fuel cell vehicle, or a hybrid vehicle, as a drive power source or an auxiliary power source, the following problems may occur. For example, when a vehicle is running, the battery is subjected to vibration and shock generated during running, and the battery element housed in the package made of waterproof film in the first related art cannot be protected from the vibration and shock applied to the battery element, only by the package.

Similarly, if the battery according to the first related art is used as a vehicle power source, air tightness may be reduced, insulation, heat resistance, and corrosion resistance against electrolyte solution may be deteriorated, and pressure uniformity may not be maintained, due to heat generated in the battery, in particular, heat generated in a current outlet portion of an electrode tab when the battery is charged with a large amount of current, and when a large amount of current is discharged from the battery. These problems may not be sufficiently prevented only by the package made of the waterproof film.

The battery with a casing according to the second related art, which is used in a compact-size electric device, is also made waterproof. However, the battery according to the second related art is mainly used in a compact-size electric device, such as a cellular phone. Therefore, if the battery according to the second related art is used as a vehicle power source, the battery housed in the casing cannot be sufficiently protected from vibration and shock only by providing waterproof seals made of the adhesive resin on outer surfaces or inner surfaces of the joint portions of the casing members, when the vibration and shock are applied to the battery during running of the vehicle.

Similarly, if the battery according to the second related art is used as a vehicle power source, air tightness may be reduced, insulation, heat resistance, and corrosion resistance against electrolyte solution may be deteriorated, and pressure uniformity may not be maintained, due to heat generated in the battery, in particular, heat generated in a current outlet portion of an electrode tab when the battery is charged with a large amount of current, and when a large amount of current is discharged from the battery. These problems may not be sufficiently prevented only by providing the aforementioned waterproof seals.

Accordingly, in Japanese Patent Application Publication No. 2005-5163 (JP-A-2005-5163), a bipolar battery, which is airtight and more effectively protected from vibration and shock, is described as a power source that can be provided in a vehicle. The bipolar battery includes at least one set of a positive electrode and a negative electrode, and a detection tab. An outer portion of a battery element is covered with at least one type of resin.

In the aforementioned bipolar battery, because resin is used as a material to form an outer battery package, the bipolar battery is made waterproof, heat resistant, and airtight. Further, because the resin surrounds and covers the entire battery element, the battery element is insulated.

Further, because the resin covers and seals the battery element, in particular, the entire areas around the current collectors, the pressure uniformity between the electrodes can be maintained. Accordingly, protection of the bipolar battery from vibration and shock can be significantly improved, because the vibration and shock generated in a vehicle are absorbed and reduced by the uniform pressure.

However, in the bipolar battery, there is a possibility that the electrolyte is decomposed by an increase of the temperature of the bipolar battery, and an inner pressure of the bipolar battery is increased due to gas generated through the decomposition, thus resulting in a short battery life. If the bipolar battery is simply covered with resin, it is difficult to prevent the increase in the temperature of the bipolar battery, because heat generated in the bipolar battery cannot be sufficiently released from the bipolar battery.

Also, when the temperature of the bipolar battery drops because the cold air outside the vehicle cools the bipolar battery, a desired battery output may not be obtained in such a cold state. In this case, it is necessary to quickly raise the temperature of the bipolar battery to an appropriate temperature.

### DISCLOSURE OF INVENTION

The invention makes it possible to easily control the temperature of a power storage device in which a power storage element is covered with a resin body.

A first aspect of the invention relates to a power storage device. The power storage device includes a power storage element, a resin body that covers the power storage element, and at least one through passage formed in the resin body.

A power storage device includes a power storage element, and a resin body that covers the power storage element. In the power storage device, at least one through passage is formed in the resin body, and a heat exchange medium is introduced into the power storage device so that heat is exchanged between the heat exchange medium and the power storage element.

The heat exchange medium may be introduced into the through passage so that the heat is exchanged between the heat exchange medium and the power storage element when the heat exchange medium flows through the through passage.

An induction tube into which the heat exchange medium is introduced may be provided inside the through passage.

The power storage device may further include a circulation passage for circulating the heat exchange medium.

The power storage device may further include a cooling device that cools the heat exchange medium, and/or a heating device that heats the heat exchange medium. The cooling device and/or the heating device may be provided in the circulation passage for circulating the heat exchange medium inside and outside the power storage device.

The cooling device may be operated when a temperature of the power storage element is above a first threshold.

The heating device may be operated when the temperature of the power storage element is below a second threshold.

An electrode terminal of the power storage element may be retained by the resin body. Further, a power storage control member related to a charge/discharge control of the power storage element may be retained by the resin body.

The power storage control member may include at least one of a detection terminal that detects voltage of the power storage element, a power storage monitoring circuit that monitors a state of charge of the power storage element, and a temperature detection sensor that detects a temperature of the power storage element.

The resin body may be formed of at least one of epoxy resin, urethane resin, nylon (polyamide) resin, olefin resin, silicone rubber, and olefin elastomer.

A second aspect of the invention relates to a manufacturing method of a power storage device. The manufacturing method includes disposing a power storage element, and disposing at least one stick member in a manner such that the stick member does not interfere with the power storage element; injecting a liquid resin material into a space around the power storage element and the stick member; and sealing the power storage element by curing the injected resin.

The resin material may include at least one of epoxy resin, urethane resin, nylon (polyamide) resin, olefin resin, silicone rubber, and olefin elastomer.

According to the aspects of the invention, heat is transferred from the power storage element to the heat exchange medium (cooling medium) when the heat exchange medium flows through the through passage. This promotes heat release from the power storage body. Further, heat carried by the heat exchange medium (heating medium) is transferred to the power storage device when the heat exchange medium flows through the through passage. This quickly raises the temperature of the power storage body in a cold state to an appropriate temperature.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 schematically shows a power supply unit according to embodiments of the invention;

FIG. 2 schematically shows the power storage unit according to a first embodiment of the invention;

FIGS. 3A and 3B schematically show a mold, more specifically, FIG. 3A is a sectional view of the mold, and FIG. 3B is a sectional view taken along the line III-III in FIG. 3A;

FIG. 4 is a flowchart showing operations to cool a bipolar battery;

FIG. 5 schematically shows a power storage unit according to a second embodiment of the invention; and

FIG. 6 is a flowchart showing operations to cool and heat the bipolar battery according to the second embodiment of the invention.

### DETAILED DESCRIPTION OF THE EMBODIMENTS

Embodiments of the invention will be hereinafter described.

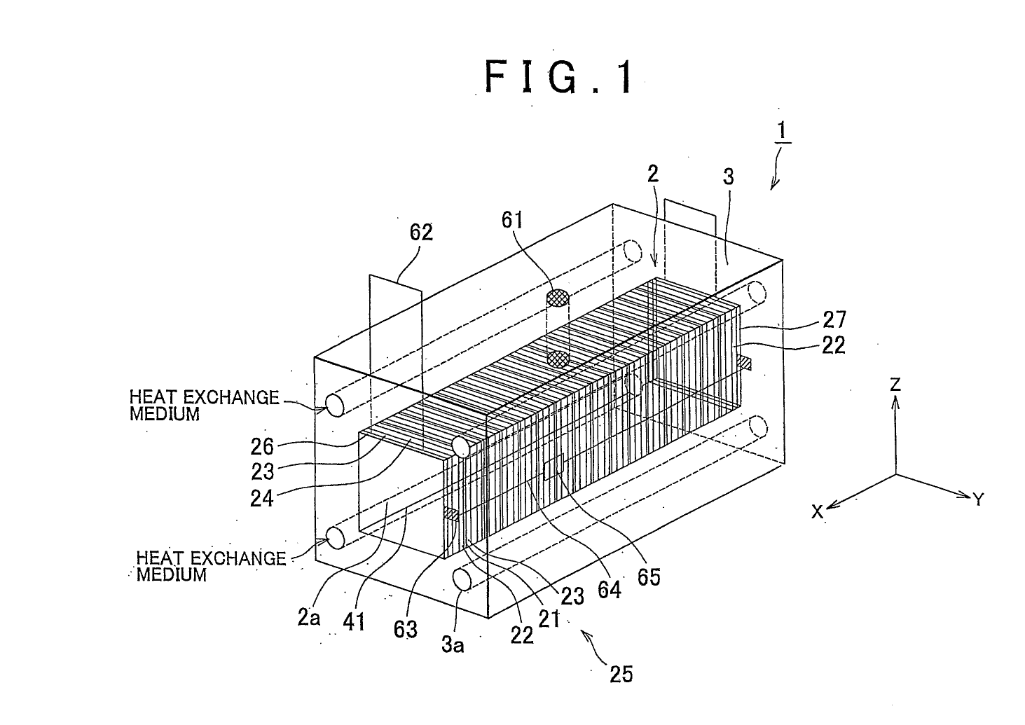

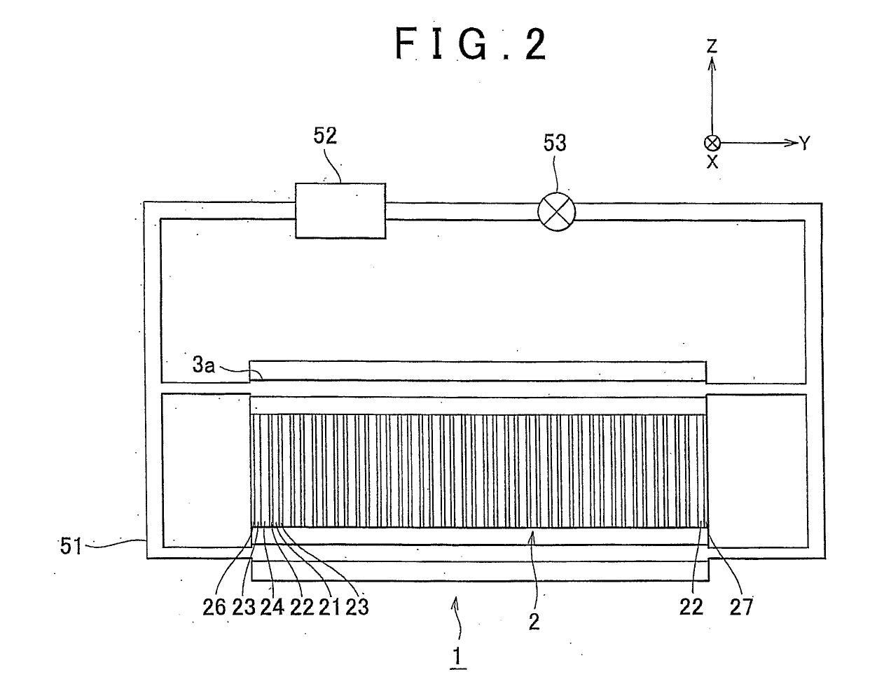

Referring to FIGS. 1 and 2, a power storage unit (power storage device) according to a first aspect of the invention will be described. FIG. 1 schematically shows the power storage unit, and shows a bipolar battery and other components disposed in a resin body, for the clear understanding of the configuration. FIG. 2 schematically shows the power storage unit.

A power storage unit 1 according to the first embodiment is used in an electric vehicle, a fuel cell vehicle, or a hybrid vehicle as a drive power source or an auxiliary power source. The power storage unit 1 can be placed, for example, under an occupant seat of a vehicle, in a space between a driver's seat and a passenger seat, or under a floor of a rear trunk room.

The power storage unit 1 includes a bipolar battery (power storage element) 2 and a rectangular prism resin body 3 that surrounds and covers the bipolar battery 2. The resin body 3 includes four through passages 3a disposed around the bipolar battery 2. The through passages 3a are formed to extend through the resin body 3 in a stacking direction of bipolar electrodes 25 of the bipolar battery 2 so that a cooling medium (heat exchange medium) is introduced into and flows through the through passages 3a.

As described above, the resin body 3 is disposed to surround and cover the bipolar battery 2, thereby making the bipolar battery 2 waterproof, heat resistant, and airtight. Further, because the resin surrounds and covers the entire battery element, the battery element is insulated. Further, the pressure uniformity between the electrodes is maintained, and this improves protection of the bipolar battery 2 from vibration and shock, because the vibration and shock, which are generated in a vehicle or the like, are absorbed and reduced by the uniform pressure.

In addition, the through passages 3a are formed to extend through the resin body 3 so that the cooling medium flows therethrough, and this promotes cooling of the bipolar battery 2 from which heat is not sufficiently released because the bipolar battery 2 is covered with the resin body 3.

Next, the configuration of the power storage unit 1 according to the invention will be described in detail. The bipolar battery 2 includes a plurality of bipolar electrodes 25, each of which includes a current collector 21, a negative electrode layer 22, and a positive electrode layer 23. The negative electrode layer 22 is provided on one surface of the current collector 21, and the positive electrode layer 23 is provided on the other surface of the current collector 22. Then, the bipolar electrodes 25 are stacked, with solid electrolyte membranes 24 interposed therebetween.

However, at one end of the bipolar battery 2 in the stacking direction of the bipolar electrodes 25, only a positive electrode current collector 26 for an electrode terminal (hereinafter referred to as a “terminal current collector 26”) is formed on the positive electrode layer 23. At the other end of the bipolar battery 2, only a negative electrode current collector 27 for an electrode terminal (hereinafter referred to as a “terminal current collector 27”) is formed on the negative electrode layer 22. It should be noted that the current collectors 21, 26, 27 may be made of, for example, aluminum foil, stainless steel foil, or copper foil.

Examples of a positive electrode active material constituting the positive electrode layer 23 include spinel LiMn₂O₄, and lithium-transition metal oxides used in a lithium ion battery containing electrolyte solution. More specifically, lithium-cobalt oxides such as LiCoO₂; lithium-nickel oxides such as LiNiO₂; lithium-manganese oxides such as spinel LiMn₂O₄; and lithium-iron oxides such as LiFeO₂ may be used as the positive electrode active material constituting the positive electrode layer 23. In addition to the materials listed above, lithium-transition metal sulfated compounds and lithium-transition metal phosphate compounds such as LiFePO₄; transition metal oxides and transition metal sulfides such as V₂O₅, MnO₂, TiS₂, MoS₂, and MoO₃; and PbO₂, AgO, and NiOOH may be used.

As a negative electrode active material constituting the negative electrode layer 22 formed on the current collector 21, transition metal oxides, lithium-transition metal oxides, titanium oxides, and Lithium-titanium oxides may be used.

The positive electrode active material and the negative electrode active material may be placed on the current collector 21, for example, by ink jet method, spray printing, electrostatic spraying, or sputtering. Note that, each of the negative electrode layer 22 and the positive electrode layer 23 may contain a binder (for example, a polymer solid electrolyte including a polymer that contains lithium salt and a polar group).

As an ion conductive material constituting the solid electrolyte membrane 24, polyethylene oxide and polypropylene may be used. The ion conductive material in a powder form contains a viscous binder mixed therein. As the viscous binder, polyvinyl alcohol (PVA), methylcellulose, nitrocellulose, ethyl cellulose, polyvinyl buthyral, vinyl acetate, polystyrene and polystyrene copolymer, ethylene-vinyl acetate copolymer, polyethylene oxide, polyacrylate, wheat starch, alginic acid soda, wax emulsion, acrylic acid ester emulsion, and polyethylene glycol may be used.

As described above, the strength of the solid electrolyte membrane 24 can be increased by mixing the viscous binder in the ion conductive material.

A circulation passage 51 is connected to each of the through passages 3a as shown in FIG. 2. A circulation pump 53 and a radiator 52 are provided in the circulation passage 51. The circulation pump 53 is used for supplying the cooling medium in the circulation passage 51 to the through passages 3a so that the coaling medium is circulated inside and outside the through passages 3a. The radiator 52 is used for cooling the cooling medium heated to a higher temperature through cooling of the bipolar battery 2. Note that, a fluorine inert liquid, an automatic transmission fluid, and silicone oil may be used as the cooling medium.

As shown in FIG. 1, power cables (electrode terminals) 62 are electrically and mechanically connected to end surfaces of the terminal current collectors 26, 27 of the bipolar battery 2, which are the surfaces positioned in a direction perpendicular to the stacking direction of the bipolar electrodes 2, so that current is withdrawn from the bipolar battery 2 through the power cables 62.

Belt-shaped tabs (power storage control members; detection terminals) 63 are electrically and mechanically connected to the current collectors 21 and the terminal current connectors 26, 27 so as to detect voltage of the bipolar battery 2. Further, the tabs 63 are electrically and mechanically connected to each other through a lead wire 64. Note that, FIG. 1 only shows the tabs 63 connected to the terminal current collectors 26, 27, and the other tabs 63 connected to the current collectors 21 of the bipolar electrodes 25 are omitted in the drawing.

The lead wire 64 is electrically and mechanically connected to a battery ECU (power storage control member; power storage monitoring circuit) 65, and a detection result obtained by the tabs 63 is output to the battery ECU 65. For example, the battery ECU 65 monitors a state of charge so that the actual state of charge is maintained around the target state of charge.

Further, a thermistor 61 (power storage control member; temperature detection sensor) is attached to the bipolar battery 2, and measures the temperature of the bipolar battery 2. The thermistor 61 is electrically and mechanically connected to the battery ECU 65. Note that, in FIG. 1, a lead wire that connects the thermistor 61 and the battery ECU 65 is omitted.

It should be noted that the power storage control members according to the invention signify auxiliary components of the bipolar battery 2 that are directly or indirectly connected to the bipolar battery 2 and related to a charge/discharge control of the bipolar battery 2. In the first embodiment, the thermistor 61, the tabs 63 for detecting voltage, and the battery ECU 65 may be regarded as the power storage control members.

The battery ECU 65 controls operations of the radiator 52 and the circulation pump 53 based on information on the temperature of the bipolar battery 2 detected by the thermistor 61. The control method will be specifically described later.

As a method of connecting the thermistor 61, the power cables 62, and the tabs 63 for detecting voltage to the bipolar battery 2, a joining method in which components are joined to each other at a low temperature, such as ultrasonic welding, may be used. Further, as a method of connecting the tabs 63 for detecting voltage to the lead wire 64, ultrasonic welding, thermal welding, laser welding, and electron beam welding may be used. Further, such connections may be made using a connector bar, such as a rivet, or by crimping.

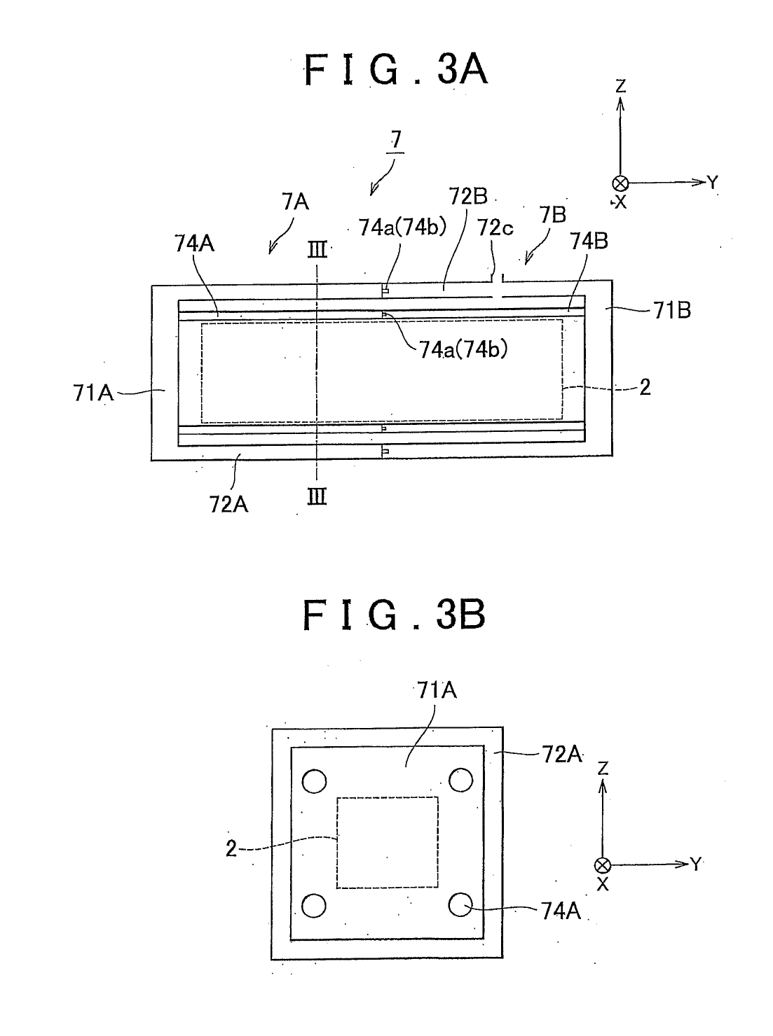

Next, referring to FIGS. 3A and 3B, a method of covering the bipolar battery 2 with the resin body 3 will be described. Each of FIGS. 3A and 3B schematically shows a mold used for appropriately covering the bipolar battery 2 with the resin body 3. FIG. 3A is a sectional view of the mold, and FIG. 3B is a sectional view taken along the line III-III in FIG. 3A.

A mold 7 includes a left mold 7A and a right mold 7B. The left mold 7A includes a base plate 71A and a sidewall 72A that extends from the periphery of the base plate 71A along a thickness direction of the base plate 71A. The right mold 7B, which is similar to the left mold 7A, includes a base plate 71B and a sidewall 72B that extends from the periphery of the base plate 71B along a thickness direction of the base plate 71B. An edge of the left mold 7A is provided with at least one attachment protrusion 72a, and an edge of the right mold 7B is provided with one attachment hole 72b or a corresponding number of attachment holes 72b.

Four resin sticks 74A are provided near four corners of the base plate 71A, and similarly, four resin sticks 74b are provided near four corners of the base plate 71B. The resin sticks 74A, 74B extend along the thickness directions of the base plates 71A, 71B. An attachment protrusion 74a is formed on an end of each of the resin sticks 74A, and an attachment hole 74b is formed on an end of each of the resin sticks 74B. The attachment protrusion 72a provided at the edge of the left mold 7A is press-fitted into the corresponding attachment hole 72b formed at the edge of the right mold 7B. At the same time, the attachment protrusions 74a of the resin sticks 74A of the left mold 7A are press-fitted into the attachment holes 74b of the respective resin sticks 74B of the right mold 7B. In this way, the left mold 7A and the right mold 7B are connected to each other.

A resin injection hole 72c is formed on the sidewall 72B of the right mold 7B so that the resin is injected into the mold 7 from outside the mold 7 through the resin injection hole 72c.

The bipolar battery 2 is placed in the mold 7 configured as described above.

Next, a liquid resin is injected into the mold 7 through the resin injection hole 72c, and then the injected resin is cured. This manufacturing method allows the resin to closely contact the bipolar battery 2 so that the bipolar battery 2 is reliably sealed. In this configuration, the power cables 62, the tabs 63 for detecting voltage, the lead wire 64, the battery ECU 65, and the thermistor 61 are fixed to the power storage unit 1 by the cured resin material at the same time. Accordingly, manufacturing efficiency can be improved.

Further, the tabs 63 for detecting voltage, the lead wire 64, the battery ECU 65, and the thermistor 61 are all retained by the resin body 3, and thus there is no need for fixing members that fix the auxiliary components to the bipolar battery 2, thereby reducing the production cost. In addition, because the power cables 62 stick out from the resin body 3, it is easy to withdraw current from the bipolar battery 2.

Note that, examples of the resin material include epoxy resin, urethane resin, nylon (polyamide) resin, olefin resin, silicone rubber, and olefin elastomer that are waterproof, damp proof, heat resistant, insulative, and flame resistant. In addition, a mixture of the resin materials listed above as examples may also be used.

Further, the resin material that is cured when a predetermined time elapses after injected into the mold 7 may be used. Also, the resin material that is thermally cured may be used. As described above, the bipolar battery 2 is easily made airtight by using the liquid resin.

When the resin is fully cured, the left mold 7A and/or the right mold 7B are/is moved along a Y-axis direction such that the united left mold 7A and the right mold 7B are separated from each other. In order to easily separate the united left and right molds 7A, 7B from each other after the resin is cured, the surfaces of the mold 7 and the resin sticks 74A, 74B (that is, the surfaces that contact the resin) may be coated with low friction material, such as fluorine resin.

In this way, the power unit 1, in which the bipolar battery 2 is covered with the resin body 3 that includes the through passages 3a, can be produced. The cooling medium flows through the through passages 3a.

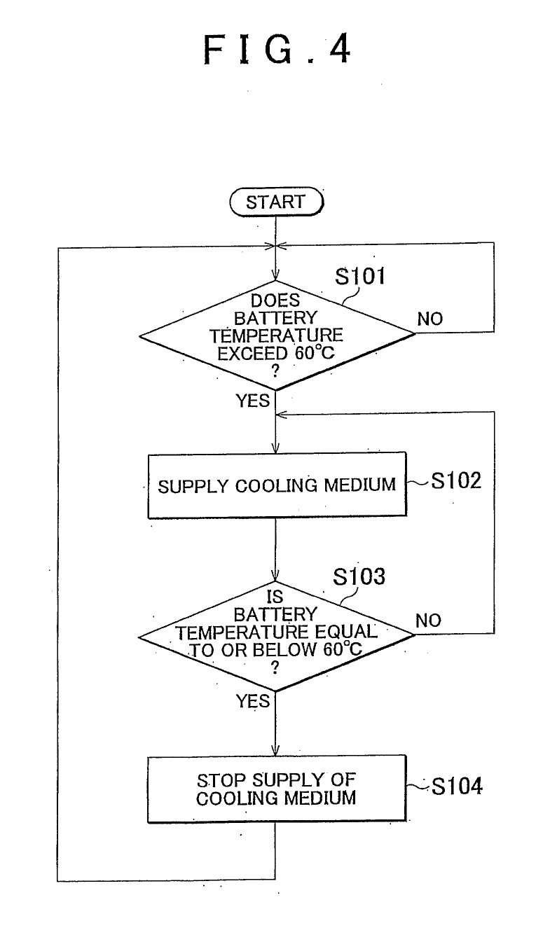

Next, referring to FIG. 4, the operations to cool the bipolar battery 2 will be described. FIG. 4 is a flowchart showing the operation to cool the bipolar battery 2. The processes in the flowchart of FIG. 4 are performed by the battery ECU 65. Further, a lithium ion battery is used as the bipolar battery 2.

In step S101, it is determined whether the temperature of the bipolar battery 2 exceeds a threshold (60° C.; a first threshold) based on the temperature information output from the thermistor 61. When it is determined that the temperature of the bipolar battery 2 exceeds the threshold, the circulation pump 53 and the radiator 52 are operated.

The first threshold is set to 60° C. because there is a possibility that an inner pressure of the lithium ion battery may increase due to gas generated therein when the lithium ion battery is left under an environment at a temperature above 60° C.

The cooling medium in the circulation passage 51 flows into the through passages 3a due to a pressure applied by the circulation pump 53, and heat of the bipolar battery 2 is transferred to the cold cooling medium flowing through the through passages 3a (step S102). In this way, the heated bipolar battery 2 can be quickly cooled.

After the cooling medium cools the bipolar battery 2, the cooling medium flows out from the through passages 3a and returns to the circulation passage 51 so that the cooling medium is cooled in the radiator 52 provided in the circulation passage 51. The cooling medium cooled in the radiator 52 flows into the through passages 3a again due to the pressure applied by the circulation pump 53.

When it is determined that the temperature of the bipolar battery 2 is equal to or below 60° C. in step S103, the radiator 52 and the circulation pump 53 are stopped, and thus, cooling of the bipolar battery 2 is stopped (step S104).

When it is determined that the temperature of the bipolar battery 2 is above 60° C. in step S103, the radiator 52 and the circulation pump 53 continue to operate, and thus, cooling of the bipolar battery 2 is continued.

As described above, the inner pressure of the bipolar battery 2 is prevented from increasing due to the gas generated in the bipolar battery 2 by controlling the temperature of the bipolar battery 2 so that the temperature of the bipolar battery 2 does not exceed 60° C.

Next, a modification example of the first embodiment of the invention will be described. In the first embodiment, the invention is described using the bipolar battery as an example. However, the invention may be applied to secondary batteries (power storage devices) other than the bipolar batteries. The secondary batteries other than the bipolar batteries may employ the electrode in which the current collector is formed of two different metals, and the positive electrode layer is formed on one surface of the current collector, and a negative layer is formed on the other surface. For example, the invention may be applied to a lithium ion battery that employs the electrode in which the positive electrode layer is formed on an aluminum surface, and the negative layer is formed on a copper surface.

In addition, the invention may be applied to an electric double-layer capacitor, which functions as the power storage device. The electric double-layer capacitor includes a plurality of positive electrodes and negative electrodes that are alternately stacked, with separators interposed therebetween. The electric double-layer capacitor may employ, for example, aluminum foil as the current collector, activated carbon as the positive electrode active material and the negative electrode active material, and a porous membrane made of polyethylene as a separator.

In the first embodiment, the cooling medium is introduced into, and flows through the through passages 3a. However, cooling gas may be introduced into, and flow through the through passages 3a. Air and nitrogen may be used as the cooling gas.

Further, in the first embodiment, the cooling medium is directly introduced into, and flows through the through passages 3a. However, cooling tubes (induction tubes) may be provided inside the through passages 3a so that the cooling medium is introduced into, and flows through the cooling tubes. With the configuration, the resin body 3 is prevented from directly contacting the cooling medium, and therefore the bipolar battery 2 can be more reliably sealed. Further, the bipolar battery 2 can be more effectively prevented from contacting the cooling medium.

Further, in the first embodiment, the through passages 3a are formed in the resin body 3 in the stacking direction of the bipolar electrodes 25 of the bipolar battery 2. In other words, the through passages 3a extend from one end to the other end in the stacking direction of the bipolar electrodes 25. However, the through passages 3a may be provided so that the through passages 3a are inclined with respect to the stacking direction of the bipolar electrodes 25. In other words, the through passages 3a may be provided at any locations as long as the through passages 3a are formed in a noninterference region in which the through passages 3a do not interfere with the surfaces of the bipolar battery 2 positioned in a direction perpendicular to the stacking direction of the bipolar electrodes 25. In summary, the through passages 3a may be provided at any locations as long as the through passages 3a do not contact the bipolar battery 2.

Next, a second embodiment of the invention will be described. In the second embodiment, the bipolar battery 2 is heated. In a cold environment, it is difficult to obtain a desired output from the bipolar battery 2, and therefore, in order to obtain the desired battery output, it is necessary to quickly raise the temperature of the bipolar battery 2 to an appropriate temperature.

For example, in the case where the bipolar battery 2 is a lithium ion battery, it is difficult to obtain the desired battery output when the battery temperature is below −10° C.

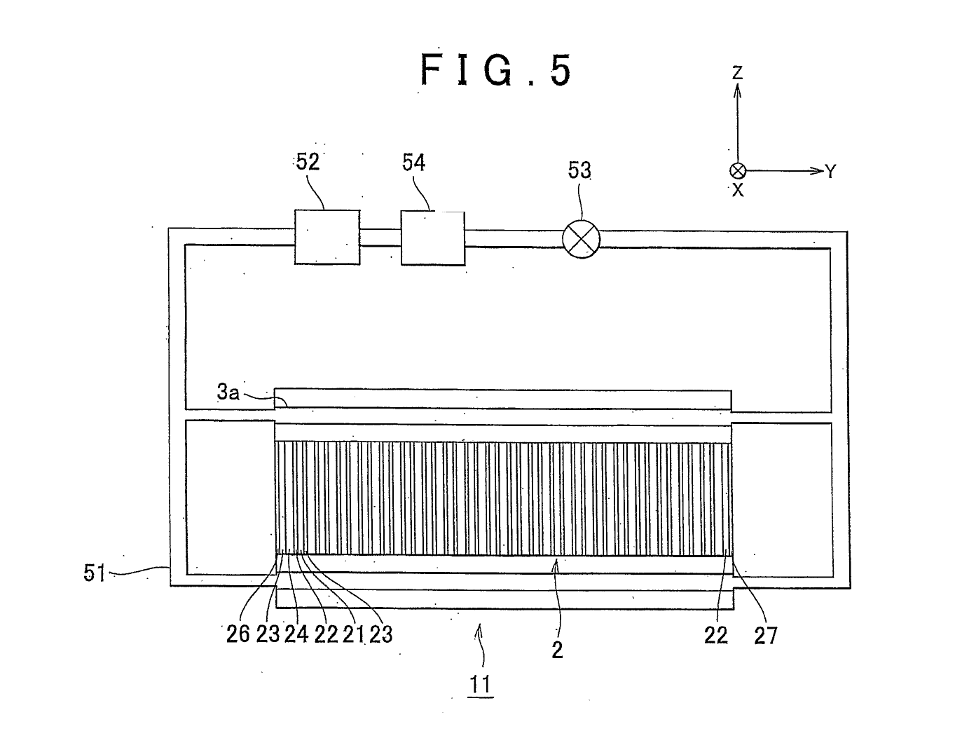

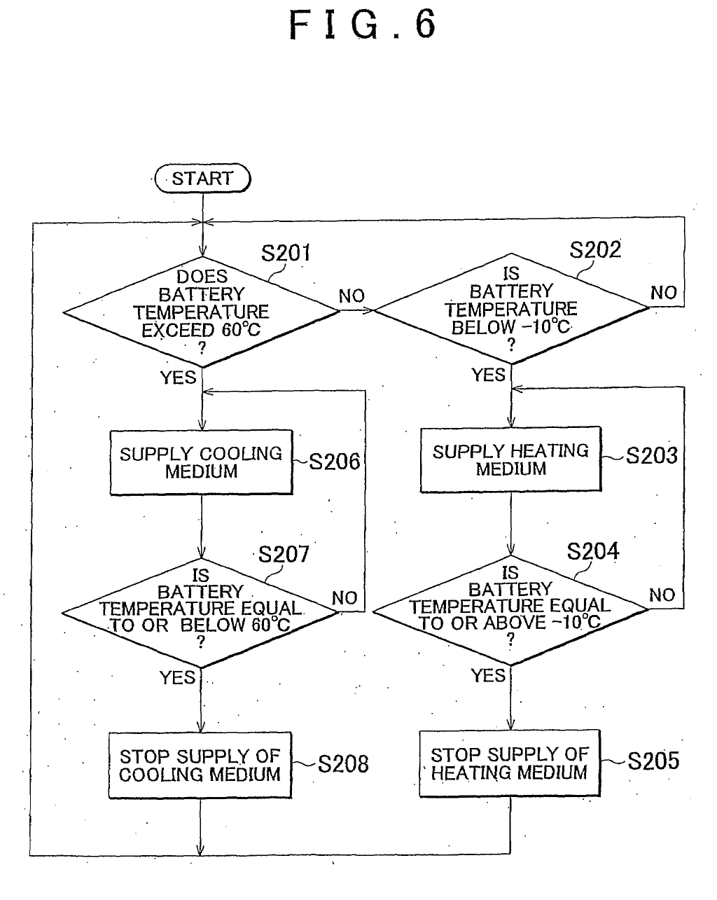

FIG. 5 schematically shows a power storage unit 11 according to the second embodiment of the invention, and FIG. 6 is a flowchart showing operations to cool and heat the bipolar battery 2 according to the second embodiment. Note that, the same constituent elements of the second embodiment as those of the first embodiment will be denoted by the same reference numerals, and the description thereof will be omitted. The processes in the flowchart shown in FIG. 6 are performed by the battery ECU 65.

In the second embodiment, a heater (heating device) 54 is provided in the circulation passage 51, in addition to the radiator 52 (cooling device) and the circulation pump 53 as described in the first embodiment.

In step S201, it is determined whether the temperature of the bipolar battery 2 exceeds 60° C. based on the temperature information output from the thermistor 61. When the temperature of the bipolar battery 2 does not exceed 60° C., it is further determined whether the temperature of the bipolar battery 2 is below −10° C. (a second threshold) in step S202. When the temperature of the bipolar battery 2 is below −10° C., the heater 54 and the circulation pump 53 are operated.

A heat exchange medium heated by the heater 54 flows into the through passages 3a by the pressure applied by the circulation pump 53, and heat carried by the heat exchange medium is transferred to the bipolar battery 2. Thus, when the bipolar battery 2 is in a cold state, and therefore, it is difficult to obtain the desired battery output, the temperature of the bipolar battery 2 is quickly raised to an appropriate temperature. Note that, a material similar to the cooling medium used in the first embodiment can be used as the heat exchange medium.

After the heat exchange medium heats the bipolar battery 2, the heat exchange medium flows out from the through passages 3a, returns to the circulation passage 51, and then is heated by the heater 54. The heat exchange medium heated by the heater 54 flows into the through passages 3a again by the pressure applied by the circulation pump 53.

When the temperature of the bipolar battery 2 reaches −10° C. or higher, the circulation pump 53 and the heater 54 are stopped, and thus, the supply of the heat exchange medium to the power storage unit 11 is stopped (step S205).

When the temperature of the bipolar battery 2 does not reach −10° C., the circulation pump 53 and the heater 54 continues to operate, and thus, the heat exchange medium continues to be supplied to the power storage unit 11.

As described above, when the temperature of the bipolar battery 2 is below −10° C., the bipolar battery 2 can be quickly heated to an appropriate temperature using the heat exchange medium. The operations to cool the bipolar battery 2 when the temperature of the bipolar battery 2 is above 60° C. (i.e., steps S201, S206, S207, and S208) are the same as those in the first embodiment, and therefore the description thereof is omitted herein.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A power storage device comprising:
a power storage element; and
a resin body that covers the power storage element,
wherein:
at least one through passage is formed in the resin body; and
a heat exchange medium is introduced into the power storage device so that heat is exchanged between the heat exchange medium and the power storage element.

2. The power storage device according to claim 1, wherein
the heat exchange medium is introduced into the through passage so that the heat is exchanged between the heat exchange medium and the power storage element when the heat exchange medium flows through the through passage.

3. The power storage device according to claim 1, wherein
an induction tube into which the heat exchange medium is introduced is provided inside the through passage.

4. The power storage device according to claim 1, further comprising:
a circulation passage for circulating the heat exchange medium.

5. The power storage device according to claim 1, further comprising:
a cooling device that cools the heat exchange medium.

6. The power storage device according to claim 5, wherein
the cooling device is provided in the circulation passage.

7. The power storage device according to claim 5, wherein
the cooling device is operated when a temperature of the power storage element is above a first threshold.

8. The power storage device according to claim 1, further comprising:
a heating device that heats the heat exchange medium.

9. The power storage device according to claim 8, wherein
the heating device is provided in the circulation passage.

10. The power storage device according to claim 8, wherein
the heating device is operated when a temperature of the power storage element is below a second threshold.

11. The power storage device according to claim 1, wherein
an electrode terminal of the power storage element is retained by the resin body.

12. The power storage device according to claim 1, wherein
a power storage control member related to a charge/discharge control of the power storage element is retained by the resin body.

13. The power storage device according to claim 1, wherein
the power storage control member includes at least one of a detection terminal that detects voltage of the power storage element, a power storage monitoring circuit that monitors a state of charge of the power storage element, and a temperature detection sensor that detects a temperature of the power storage element.

14. The power storage device according to claim 1, wherein
the resin body is formed of at least one of epoxy resin, urethane resin, polyamide resin, olefin resin, silicone rubber, and olefin elastomer.

15. A manufacturing method of a power storage device, comprising:
disposing a power storage element, and disposing at least one stick member in a manner such that the stick member does not interfere with the power storage element;
injecting a liquid resin material into a space around the power storage element and the stick member; and
sealing the power storage element by curing the injected resin.

16. The manufacturing method according to claim 15, wherein
the resin material includes at least one of epoxy resin, urethane resin, polyamide resin, olefin resin, silicone rubber, and olefin elastomer.
